(19) United States
(12) Patent Application Publication
(10) Pub. No.: US 2013/0134805 A1
(43) Pub. Date: May 30, 2013

(54) SWITCHED RELUCTANCE MOTOR

(71) Applicants: Sung Tai JUNG, Gyunggi-do (KR); Chee Woo LEE, Gyunggi-do (KR); Han Kyung BAE, Gyunggi-do (KR)

(72) Inventors: Sung Tai JUNG, Gyunggi-do (KR); Chee Woo LEE, Gyunggi-do (KR); Han Kyung BAE, Gyunggi-do (KR)

(73) Assignee: SAMSUNG ELECTRO-MECHANICS CO., LTD., Gyunggi-do (KR)

(21) Appl. No.: 13/424,883

(22) Filed: Mar. 20, 2012

(30) Foreign Application Priority Data
Nov. 29, 2011 (KR) 1020110126165

(51) Int. Cl. H02K 21/38

(52) U.S. Cl. 310/46

(57) ABSTRACT

Disclosed herein is a switched reluctance motor including: a salient pole type rotor provided with a plurality of salient poles; and a stator including a stator body provided with a plurality of salient poles facing the rotor, a plurality of phase windings formed by winding coils around the salient poles, and permanent magnets mounted between the phase windings, wherein the permanent magnets are disposed to generate magnetic force in a direction corresponding to a direction in which magnetic fluxes are generated from the phase windings.

### CROSS REFERENCE TO RELATED APPLICATION

This application claims the benefit of Korean Patent Application No. 10-2011-0126165, filed on Nov. 29, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

In a general switched reluctance motor, both of a stator and a rotor have a salient pole type magnetic structure. In addition, the stator has a concentrated type coil wound therearound, and the rotor is configured only of an iron core without any type of excitation device (a winding, a permanent magnet, or the like), such that a competitive cost is excellent. Further, a speed changeable switched reluctance motor stably generates a continuous torque with the aid of a converter using a power semiconductor and a position sensor and is easily controlled to be appropriate for performance required in each application.

In the case of various alternate current (AC) motors (an induction motor, a permanent magnet synchronous motor, or the like) and a brushless direct current (DC) motor, when a significant improvement in performance is required with the passage of time after design of one electromagnetic field structure is completed, the electromagnetic field structure should be re-designed as a new electromagnetic field structure. Otherwise, there is no way except for a simple design change replacing a high cost material such as steel, a permanent magnet, or the like, which is not an efficient design. The switched reluctance motor also has the above-mentioned problem.

More specifically, a switched reluctance motor according to the prior art, includes a rotor and a stator provided with salient poles. A coil is wound around the salient pole to form a phase winding. In the case in which current is applied to the phase winding, a magnetic flux is generated and attractive force is generated between the salient pole of the stator and the rotor, such that the rotor rotates.

In addition, a plurality of salient poles are formed in the stator, the coils are wound around the plurality of salient poles to form a plurality of phase windings, and each of the plurality of phase windings is excited to generate a torque, thereby rotating the rotor. However, in the switched reluctance motor according to the prior art, since only the windings are excited to generate the torque, torque density, efficiency, and the like, are limited. In addition, when the switched reluctance motor according to the prior art is implemented as a switched reluctance motor having a plurality of phases, core less increases due to intersection of a magnetic flux.

### SUMMARY OF THE INVENTION

The present invention has been made in an effort to provide a switched reluctance motor in which a plurality of phase windings are formed by winding coils around salient poles of a stator and permanent magnets are mounted between the plurality of phase windings, wherein magnetic fluxes generated by excitation of the phase windings interact with magnetic fluxes generated from the permanent magnets, such that a magnetic flux amount may increase and torque density may be improved, and an intersection line is not generated in the magnetic fluxes generated by the excitation of the phase windings, such that core loss may be reduced.

According to a preferred embodiment of the present invention, there is provided a switched reluctance motor including: a salient pole type rotor provided with a plurality of salient poles; and a stator including a stator body provided with a plurality of salient poles facing the rotor, a plurality of phase windings formed by winding coils around the salient poles, and permanent magnets mounted between the phase windings, wherein the permanent magnets are disposed to generate magnetic force in a direction corresponding to a direction in which magnetic fluxes are generated from the phase windings.

2n salient poles of the stator body may be formed at equipitch in a circumferential direction of the stator body, and the phase windings may be two-phase windings formed by winding the coils around the salient poles.

An intersection line may not be generated in the magnetic fluxes generated by excitation of the phase windings.

The permanent magnet may include: two first permanent magnets mounted at an outer peripheral portion of the stator body in a radial direction; and a single second permanent magnet mounted at an inner peripheral portion of the stator body in the radial direction, wherein the second permanent magnet is positioned between the two first permanent magnets.

2n salient poles of the rotor may be formed at equipitch in a circumferential direction of the rotor.

3n salient poles of the stator body corresponding to the salient poles of the rotor may be formed at equipitch in a circumferential direction of the stator body, the phase windings may be three-phase windings formed by winding the coils around the salient poles, and the permanent magnets may be mounted between the three-phase windings.

3n salient poles of the rotor may be formed at equipitch in a circumferential direction of the rotor.

According to another preferred embodiment of the present invention, there is provided a switched reluctance motor including: a salient pole type rotor provided with a plurality of salient poles; and a stator including a stator body provided with a plurality of salient poles facing the rotor, a plurality of phase windings formed by winding coils around the salient poles, and permanent magnets mounted between the phase windings, wherein the permanent magnet includes: two first permanent magnets mounted at an outer peripheral portion of the stator body in a radial direction; and a single second permanent magnet mounted at an inner peripheral portion of the stator body in the radial direction, the second permanent magnet being positioned between the two first permanent magnets.

2n salient poles of the stator body may be formed at equipitch in a circumferential direction of the stator body, and the phase windings may be two-phase windings formed by winding the coils around the salient poles.

An intersection line may not be generated in the magnetic fluxes generated by excitation of the phase windings.

The permanent magnet may include: two first permanent magnets mounted at an outer peripheral portion of the stator body in a radial direction; and a single second permanent magnet mounted at an inner peripheral portion of the stator body in the radial direction, wherein the second permanent magnet is positioned between the two first permanent magnets.

2n salient poles of the rotor may be formed at equipitch in a circumferential direction of the rotor.

3n salient poles of the stator body corresponding to the salient poles of the rotor may be formed at equipitch in a circumferential direction of the stator body, the phase windings may be three-phase windings formed by winding the coils around the salient poles, and the permanent magnets may be mounted between the three-phase windings.

3n salient poles of the rotor may be formed at equipitch in a circumferential direction of the rotor.

### BRIEF DESCRIPTION OF THE DRAWINGS

FIG. 1 is a schematic configuration view of a switched reluctance motor according to a first preferred embodiment of the present invention;

FIG. 2 is a schematic use state view showing magnetic flux distribution at the time of excitation of a first-phase winding in the switched reluctance motor shown in FIG. 1;

FIG. 3 is a schematic use state view showing magnetic flux distribution at the time of excitation of a second-phase winding in the switched reluctance motor shown in FIG. 1; and

FIG. 4 is a schematic configuration view of a switched reluctance motor according to a second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a switched reluctance motor according to preferred embodiments of the present invention will be described with reference to the accompanying drawings.

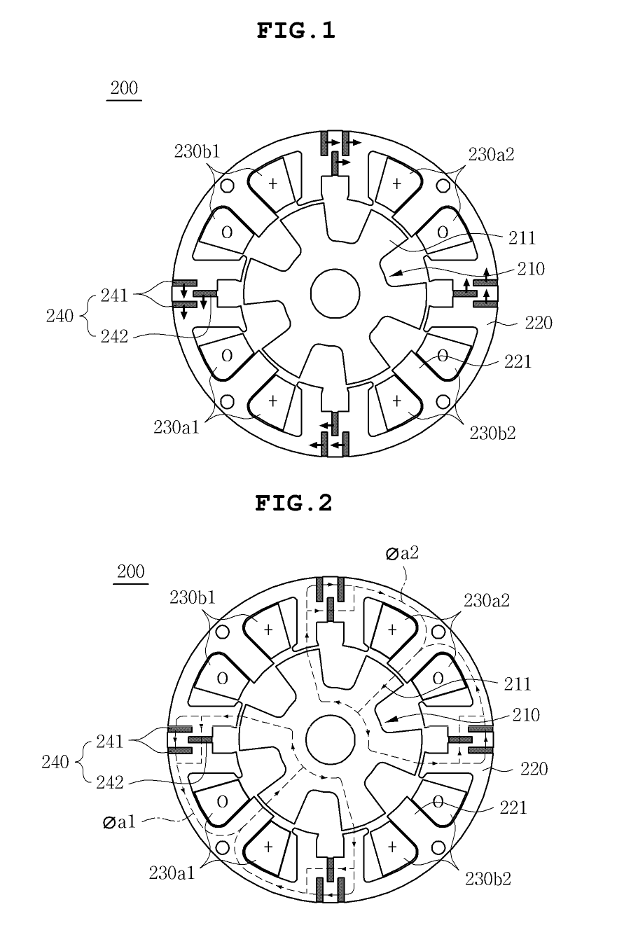

FIG. 1 is a schematic configuration view of a switched reluctance motor according to a first preferred embodiment of the present invention. As shown, the switched reluctance motor 200 includes a rotor 210 and a stator, wherein the rotor 210 rotates by electromagnetic force with the stator.

More specifically, the rotor 210 is rotatably disposed at an inner side of the stator and is implemented as a salient poly type rotor including a plurality of salient poles 211 formed at an outer peripheral portion thereof in a radial direction. In addition, six salient poles 211 of the rotor are formed at equipitch in a circumferential direction of the rotor.

Further, the stator includes a stator body 220, phase windings 230a1, 230a2, 230b1, and 230b2, and permanent magnets 240. In addition, the stator body 220 is provided with a plurality of salient poles 221 protruded in an inner diameter direction so as to face the rotor and disposed at equipitch in the circumferential direction. Further, the phase windings 230a1, 230a2, 230b1, and 230b2 are formed by winding coils around the plurality of salient poles 221 of the stator body 220 respectively.

In addition, the permanent magnets 240, which are to improve torque density by adding their magnetic force to magnetic fluxes generated by excitation of the phase windings 230a1, 230a2, 230b1, and 230b2, are positioned between the plurality of phase windings 230a1, 230a2, 230b1, and 230b2, and are mounted in the stator body 220.

FIG. 1 shows a two-phase switched reluctance motor. To this end, the number of salient poles 221 of the stator body 220 is 4, which is 2n, and each of the coils is concentratedly wound around four salient poles 221, such that two-phase phase windings 230a1, 230a2, 230b1, and 230b2 having an A phase and a B phase are formed.

Further, the permanent magnets 240 are disposed to generate magnetic force in a direction corresponding to a direction in which the magnetic fluxes are generated from the phase windings 230a1, 230a2, 230b1, and 230b2. In addition, the number of permanent magnets 240 according to the preferred embodiment of the present invention is not limited. However, it is preferable that three permanent magnets 240 are mounted between each of two of the phase windings 230a1, 230a2, 230b1, and 230b2 of the stator body, two first permanent magnets 241 are mounted at an outer peripheral portion of the stator body in the radial direction, a single second magnet 242 is mounted at an inner peripheral portion of the stator body in the radial direction, and the second permanent magnet 242 is positioned between the two first permanent magnets 241, in consideration of intensity of magnetic force. Further, the second permanent magnet 242 is positioned at an inner peripheral surface of the stator body 220 in the radial direction in contrast with the first permanent magnet 241.

As described above, the switched reluctance motor 200 shown in FIG. 1 is a two-phase switched reluctance motor. An even-phase switched reluctance motor corresponding to 2n (n indicates a positive integer) is designed so that directions of the permanent magnets and the magnetic flexes are determined as in the switched reluctance motor shown in FIG. 1.

FIG. 2 is a schematic use state view showing magnetic flux distribution at the time of excitation of a first-phase winding in the switched reluctance motor shown in FIG. 1. As shown, in the switched reluctance motor 200, when A phase windings 230a1 and 230a2, which are first-phase windings, of the phase windings have a current applied thereto to be excited, magnet fluxes are generated. More specifically, the magnetic fluxes (Φa1 and Φa2) are generated by magnetic fluxes of the A phase windings and magnetic force of the permanent magnets. Here, a direction of the magnetic force of the permanent magnets 240 corresponds to that of the magnetic fluxes generated from the phase windings as shown by an arrow in FIG. 1, such that torque density is improved and an intersection line is not generated in the magnetic fluxes at any position of the stator, thereby reducing core loss. That is, the magnetic flux has a short path, such that an inductance increases. Furthermore, due to the permanent magnet, a magnetic flux amount increases and attractive force is improved, such that the rotor rotates. In addition, various permanent magnets according to magnetic force are adopted, thereby making it possible to vary torque density.

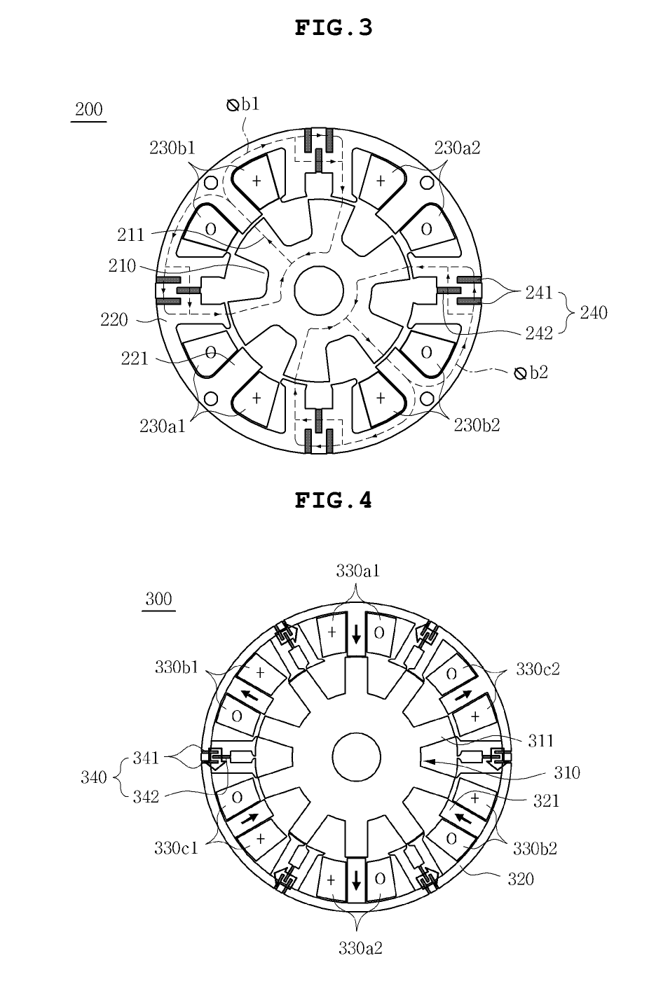

FIG. 3 is a schematic use state view showing magnetic flux distribution at the time of excitation of a second-phase winding in the switched reluctance motor shown in FIG. 1. As shown, in the switched reluctance motor 200, when B phase windings 230b1 and 230b2, which are second-phase windings, of the phase windings have a current applied thereto to be excited, magnetic fluxes (Φb1 and (Φb2) are generated. In this case, a direction of the magnetic force of the permanent magnets 240 corresponds to that of the magnetic fluxes generated from the B phase windings 230b1 and 230b2, such that torque density is improved. In addition, various permanent magnets according to magnetic force are adopted, thereby making it possible to vary torque density.

FIG. 4 is a schematic configuration view of a switched reluctance motor according to a second preferred embodiment of the present invention. As shown, the switched reluctance motor 300 is implemented as a three-phase switched reluctance motor, in contrast with the switched reluctance motor 200 according to the first preferred embodiment of the present invention shown in FIG. 1.

To this end, the switched reluctance motor 300 is configured to include a rotor 310 and a stator including a stator body 320, phase windings 330, and permanent magnets 340.

More specifically, the rotor 310 is rotatably disposed at an inner side of the stator and is implemented as a salient poly type rotor including a plurality of salient poles 311 formed at an outer peripheral portion thereof in a radial direction. In addition, ten salient poles 311, which are a plurality of salient poles, of the rotor are formed at equipitch in a circumferential direction of the rotor.

Further, six salient poles 321, which are 3n salient poles, of the stator body 320 are formed, and each of the coils is concentratedly wound around the six salient poles 221, such that three-phase phase windings 330a1, 330a2, 330b1, 330b2, 330c1, and 330c2 having a U phase, a V phase, and a W phase are formed.

Further, the permanent magnets 340 are disposed to generate magnetic force in a direction corresponding to a direction in which the magnetic fluxes are generated from the phase windings 330a1, 330a2, 330b1, 330b2, 330c1, and 330c2. In addition, the number of permanent magnets 340 according to the preferred embodiment of the present invention is not limited. However, three permanent magnets 340 are mounted between each of two of the phase windings 330a1, 330a2, 330b1, 330b2, 330c1, and 330c2 of the stator body, two first permanent magnets 341 are mounted at an outer peripheral portion of the stator body in the radial direction, a single second magnet 342 is mounted at an inner peripheral portion of the stator body in the radial direction, and the second permanent magnet 342 is positioned between the two first permanent magnets 341, in consideration of the intensity of magnetic force. Further, the second permanent magnet 342 is positioned at an inner peripheral surface of the stator body 320 in the radial direction in contrast with the first permanent magnet 341.

Through the above-mentioned configuration, the switched reluctance motor 300 allows a direction of the magnetic fluxes to intersect with each other in a sequence of a U phase winding 330a1, a V phase winding 330b1, a W phase winding 330c1, a U phase winding 330a2, a V phase winding 330b2, and a W phase winding 330c2 in a counterclockwise direction, unlike the two-phase switched reluctance motor 200, such that intersection of the magnetic fluxes is not generated at any position. In addition, the permanent magnets 340 are mounted so that magnetic force is generated in a direction corresponding to the direction of the magnetic fluxes of the phase winding, that is, the magnetic force is generated in the direction shown by an arrow, thereby making it possible to improve torque density.

As described above, the switched reluctance motor 300 shown in FIG. 4 is the thee-phase switched reluctance motor. This odd-phase switched reluctance motor may be designed so that directions of the permanent magnets and the magnetic fluxes are determined as in the switched reluctance motor 300 shown in FIG. 4.

As set forth above, according to the preferred embodiments of the present invention, it is possible to provide a switched reluctance motor in which the plurality of phase windings are formed by winding the coils around the salient poles of the stator and the permanent magnets are mounted between the phase windings, wherein the magnetic fluxes generated by excitation of the phase windings interact with the magnetic force generated from the permanent magnets, such that a magnetic flux amount may increase and torque density may be improved, and an intersection line is not generated in the magnetic fluxes generated by the excitation of the phase windings, such that core loss may be reduced.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a salient pole type rotor provided with a plurality of salient poles; and
a stator including a stator body provided with a plurality of salient poles facing the rotor, a plurality of phase windings formed by winding coils around the salient poles, and permanent magnets mounted between the phase windings,
wherein the permanent magnets are disposed to generate magnetic force in a direction corresponding to a direction in which magnetic fluxes are generated from the phase windings.

2. The switched reluctance motor as set forth in claim 1, wherein 2n salient poles of the stator body are formed at equipitch in a circumferential direction of the stator body, and the phase windings are two-phase windings formed by winding the coils around the salient poles.

3. The switched reluctance motor as set forth in claim 1, wherein an intersection line is not generated in the magnetic fluxes generated by excitation of the phase windings.

4. The switched reluctance motor as set forth in claim 1, wherein the permanent magnet includes:
two first permanent magnets mounted at an outer peripheral portion of the stator body in a radial direction; and
a single second permanent magnet mounted at an inner peripheral portion of the stator body in the radial direction, the second permanent magnet being positioned between the two first permanent magnets.

5. The switched reluctance motor as set forth in claim 1, wherein 2n salient poles of the rotor are formed at equipitch in a circumferential direction of the rotor.

6. The switched reluctance motor as set forth in claim 1, wherein 3n salient poles of the stator body corresponding to the salient poles of the rotor are formed at equipitch in a circumferential direction of the stator body, the phase windings are three-phase windings formed by winding the coils around the salient poles, and the permanent magnets are mounted between the three-phase windings.

7. The switched reluctance motor as set forth in claim 1, wherein 3n salient poles of the rotor are formed at equipitch in a circumferential direction of the rotor.

8. A switched reluctance motor comprising:
a salient pole type rotor provided with a plurality of salient poles; and
a stator including a stator body provided with a plurality of salient poles facing the rotor, a plurality of phase windings formed by winding coils around the salient poles, and permanent magnets mounted between the phase windings,
wherein the permanent magnet includes:
two first permanent magnets mounted at an outer peripheral portion of the stator body in a radial direction; and
a single second permanent magnet mounted at an inner peripheral portion of the stator body in the radial direction.

9. The switched reluctance motor as set forth in claim 8, wherein 2n salient poles of the stator body are formed at equipitch in a circumferential direction of the stator body, and the phase windings are two-phase windings formed by winding the coils around the salient poles.

10. The switched reluctance motor as set forth in claim 8, wherein an intersection line is not generated in the magnetic fluxes generated by excitation of the phase windings.

11. The switched reluctance motor as set forth in claim 8, wherein the second permanent magnet being positioned between the two first permanent magnets.

12. The switched reluctance motor as set forth in claim 8, wherein 2n salient poles of the rotor are formed at equipitch in a circumferential direction of the rotor.

13. The switched reluctance motor as set forth in claim 8, wherein 3n salient poles of the stator body corresponding to the salient poles of the rotor are formed at equipitch in a circumferential direction of the stator body, the phase windings are three-phase windings formed by winding the coils around the salient poles, and the permanent magnets are mounted between the three-phase windings.

14. The switched reluctance motor as set forth in claim 8, wherein 3n salient poles of the rotor are formed at equipitch in a circumferential direction of the rotor.
